(19) United States
(12) Patent Application Publication
(10) Pub. No.: US 2023/0046549 A1
(43) Pub. Date: Feb. 16, 2023

(54) COATING COMPOSITION

(71) Applicant: PPG Industries Ohio, Inc., Cleveland, OH (US)

(72) Inventors: Mark Poland, Merseyside (GB); Jacopo Milani, Merseyside (GB)

(73) Assignee: PPG Industries Ohio, Inc., Cleveland, OH (US)

(21) Appl. No.: 17/760,123

(22) PCT Filed: Feb. 5, 2021
(86) PCT No.: PCT/US2021/016804

§ 371 Date: Aug. 4, 2022

Related U.S. Application Data
(60) Provisional application No. 62/971,551, filed on Feb. 7, 2020.

(51) Int. Cl. C09D 127/18

(52) U.S. Cl. CPC C09D 127/18

(57) ABSTRACT

The present disclosure relates to a coating composition, comprising a fluoropolymer component in the form of a fluoropolymer micropowder having a weight average molecular weight of from 300,000 g/mol to 400,000 g/mol, a binder resin, a hydroxy-functional silicone resin; and a silicone oil, as well as articles coated with the composition.

### CROSS-REFERENCE TO RELATED APPLICATIONS

This application claims the benefit under Title 35, U.S.C. § 119(e) of U.S. Provisional Patent Application Ser. No. 62/971,551, filed Feb. 7, 2020, entitled COATING COMPOSITION, the disclosure of which is incorporated by reference herein in its entirety.

### BACKGROUND

### 1. Field of the Disclosure

The present disclosure relates to coatings, such as coatings of the type used on rigid substrates such as bakeware, cookware or other applications in which a non-stick surface is desired. In particular, the present disclosure relates to a coating having improved non-stick or release characteristics.

### 2. Description of the Related Art

Non-stick coating formulation technology encompasses the use of various non-stick components, binder systems, and additives to provide the required release properties. Silicone oils and fluoropolymers, such as polytetrafluoroethylene (PTFE), are widely known non-stick components used in coating formulations. Coatings containing silicone oil and fluoropolymers exhibit low surface energy and, consequently, it is very difficult for other substances to adhere to the surface of coated items, such as pans, baking trays or roasters, thereby providing ‘non-stick’ or release properties.

Silicone oils offer very good release properties but only for a limited period of time. The low average molecular weight and the substantial incompatibility with the bulk of the coating film results in the migration of the silicone oil to the uppermost coating layers and eventually results in the silicone oil being lost from the coating such that, over time, with repeated use, the silicone oil disappears. Consequently, the release properties of coatings containing silicone oil rapidly decrease.

Fluoropolymers have been successfully introduced in non-stick coating formulations to avoid the rapid performance loss of coatings containing silicone oil. Due to their high average molecular weight, fluoropolymers remain in the film for longer despite their incompatibility with the film bulk. However, as to release properties, the performance of fluoropolymers is generally lower than the performance provided by silicone oils.

What is needed is a coating system having the release properties of a coating containing silicone oil together with the performance endurance which is typical of a coating containing a fluoropolymer.

### SUMMARY

The present disclosure relates to a formulation of a coating composition, including a fluoropolymer component, a silicone oil and a hydroxy-functional silicone resin. The composition may be incorporated into a resin binder to provide a coating formulation with improved release performance and durability.

The coating formulation includes a fluoropolymer component, a silicone oil, a hydroxy-functional silicone resin and a resin binder system, and may be applied to a rigid substrate, such as an article of cookware or bakeware, for example, baking tins, roasting tins, rice cookers, saucepans, frying pans, waffle makers and the like.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the disclosure taken in conjunction with the accompanying drawings, wherein:

FIG. 1 shows a Scanning Electron Microscopy (SEM) image showing a silicone oil/fluoropolymer coating surface after curing.

FIG. 2 shows an image of a silicone oil/fluoropolymer coating at 50× magnification.

FIG. 3 shows an image of a silicone oil/fluoropolymer coating at 150× magnification.

FIG. 4 shows an Energy Dispersive Spectroscopy (EDS, elemental analysis) of a silicone oil/fluoropolymer coating.

FIG. 5 shows an Energy Dispersive Spectroscopy (EDS, elemental analysis) layered image of the coating surface of FIG. 1.

FIG. 6 is an Energy Dispersive X-ray (EDX) image showing the distribution of fluorine atoms in the coating of FIG. 1.

FIG. 7 shows an EDX image showing the distribution of silicone atoms in the coating of FIG. 1.

FIG. 8 shows blooming on a metal panel coated with a formulation containing silicone fluid and fluoropolymer as described in Comparative Example A.

FIG. 9 shows an SEM image of a coating surface of the present disclosure.

FIG. 10 shows an SEM image of a coating surface of the present disclosure, as described in Example 1.

FIG. 11 shows an EDX image (Si Kα₁) of the coating of FIG. 9.

FIG. 12 shows an EDS layered image of a coating surface of the present disclosure.

FIG. 13 shows an EDS qualitative analysis showing the distribution of sulfur, silicon (surrounding the fluoropolymer agglomerates) and fluorine across the coated surface as described in Example 1.

FIG. 14 shows an EDX image (Si Kα₁) of the coating of FIG. 9.

FIG. 15 shows an EDX image (F Kα_{1,2}) of the coating of FIG. 9.

FIG. 16 shows an EDX image (F Kα_{1,2}) of the coating of FIG. 9.

FIG. 17 shows an SEM image of a coating surface containing fluorinated ethylene propylene (FEP) at 500× magnification as described in Example 2.

FIG. 18 shows an SEM image of a coating surface containing fluorinated ethylene propylene (FEP) at 120× magnification as described in Example 2.

FIG. 19 shows an EDX image of the distribution of Si and F in the coating containing fluorinated ethylene propylene (FEP) as described in Example 2.

FIG. 20 shows an SEM image of a coating surface containing perfluoroalkoxy (PFA) at 120× magnification as described in Example 3.

FIG. 21 shows an EDX image of the distribution of Si and F in the coating containing perfluoroalkoxy (PFA) as described in Example 3.

FIG. 22 shows an SEM image of a coating surface containing fluorinated ethylene propylene (FEP) and polyamide-imide (PAI) at 500× magnification as described in Example 4.

FIG. 23 shows an EDX image of the distribution of Si and F of the coating containing fluorinated ethylene propylene (FEP) and polyamide-imide PAI as described in Example 4.

FIG. 24 shows an SEM image showing the surface of a standard fluoropolymer containing coating product as described in Example 6.

FIG. 25 shows an EDS compositional analysis of a standard fluoropolymer containing product as described in Example 6.

FIG. 26 shows test results of a cake release test for a fluoropolymer coating as described in Example 6.

FIG. 27 shows test results of a cake release test for a coating of the present disclosure as described in Example 6.

FIG. 28 shows test results of a cake release test for the coating of the present disclosure as described in Example 6.

FIG. 29 shows test results of a cake release test for the coating of the present disclosure as described in Example 6.

### DETAILED DESCRIPTION

1. Introduction.

The coating formulation of the present disclosure provides a fluoropolymer-silicone coating having a combination of improved release properties and durability. Silicone-containing coatings generally provide the benchmark for release properties, while fluoropolymer-containing coatings represent the benchmark for longevity of the non-stick performance.

Both silicone oil and fluoropolymers provide a non-stick function only when they are present at the surface of a coating film. The migration of the silicone oil and fluoropolymer to the uppermost coating layer is achieved during the curing process due to their substantial incompatibility with the resin bulk.

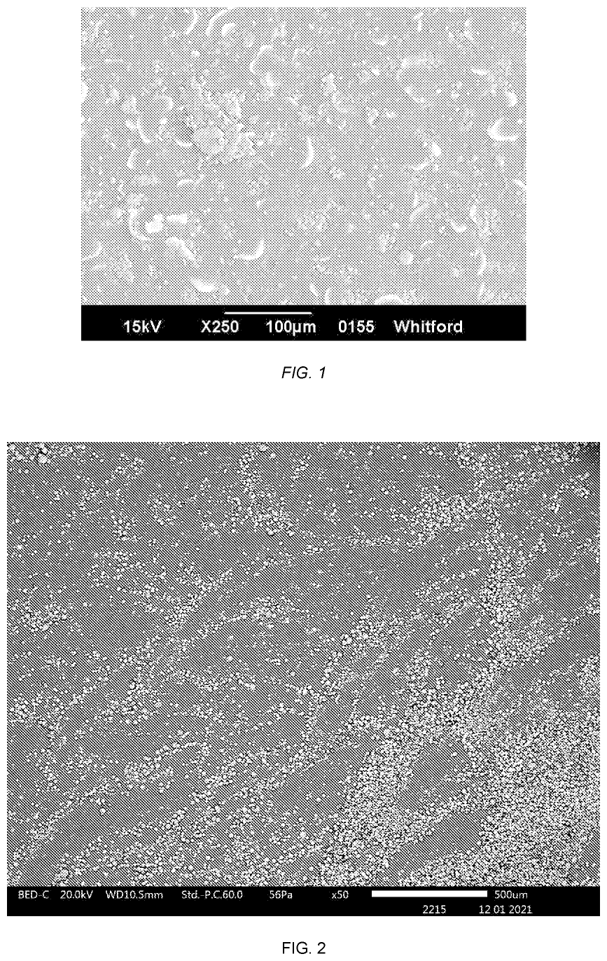

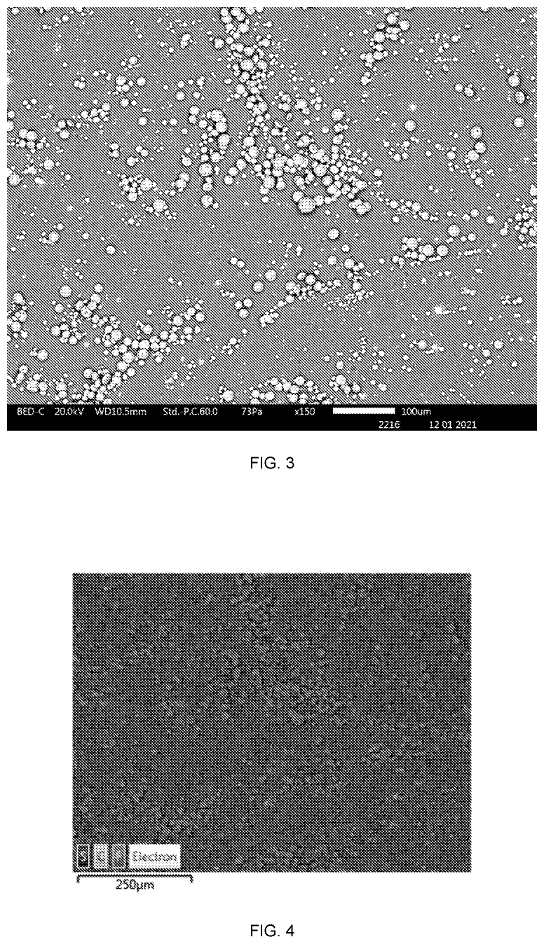

As described above, silicone oils have very good release properties. However, the use of silicone materials in combination with fluoropolymers in a thermoplastic binder medium proved to not be successful. In coil coating technology, the introduction of silicone oil in fluoropolymer containing coatings based on a polyethersulfone (PES) resin binder proved to not be a viable solution. It was found that when silicone oil is included in a PES based formulation (thermoplastic resin with a glass transition temperature (T_{g}) >220° C.) also containing fluoropolymer, a blooming phenomenon is observed on the cured film. This blooming effect is shown in FIG. 1. FIG. 1 shows an SEM image (15 kV) showing a silicone oil/fluoropolymer (w/w) coating surface after curing. The fluoropolymer appears neither homogeneously distributed on the surface, nor properly bonded to the resin matrix, resulting in fluoropolymer blooming, a phenomenon described further below. FIG. 2 and FIG. 3 show this phenomenon under 50× and 150× magnification, respectively. FIG. 4 is a compositional analysis, showing the elemental distribution of sulfur, carbon and fluorine across the coated surface

The incompatibility of silicone oil with the fluoropolymer results in the appearance of a deposit of fluoropolymer dry powder that can be easily removed from the coating surface after the curing process. This phenomenon is thought to be caused by the silicone oil migrating to the surface of the coating film during the curing process. Without intending to be bound by theory, it is believed that being surrounded by the silicone oil, the fluoropolymer molecules are inhibited from bonding or ‘anchoring’ to the resin matrix. The fluoropolymer that is also present at the film uppermost layer is ‘squeezed out’ of the coating. The result is fluoropolymer powder on the coating surface not bonded to the PES resin matrix, a phenomenon known as “blooming”.

The substantial incompatibility in the system brings about a blooming effect at the surface level resulting from the fluoropolymer being not bonded to the resin matrix. The high degree of incompatibility between the two ingredients and the resin binder results in fluoropolymer blooming.

As further described below in Comparative Example A, a coating prepared using a formulation containing silicone fluid and a fluoropolymer results in blooming once slight friction is applied to the coating, as shown in FIG. 8. The coating described in Comparative Example A lacks the hydroxy functionalized silicone resin included in the coatings of the present disclosure.

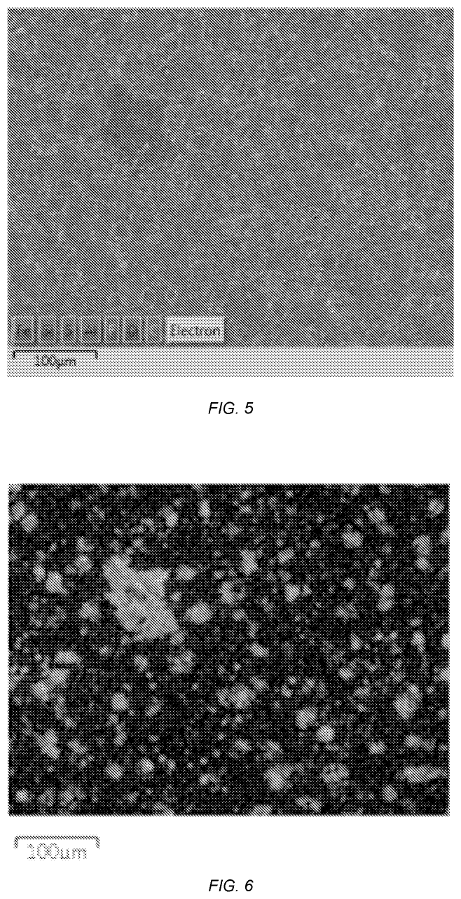

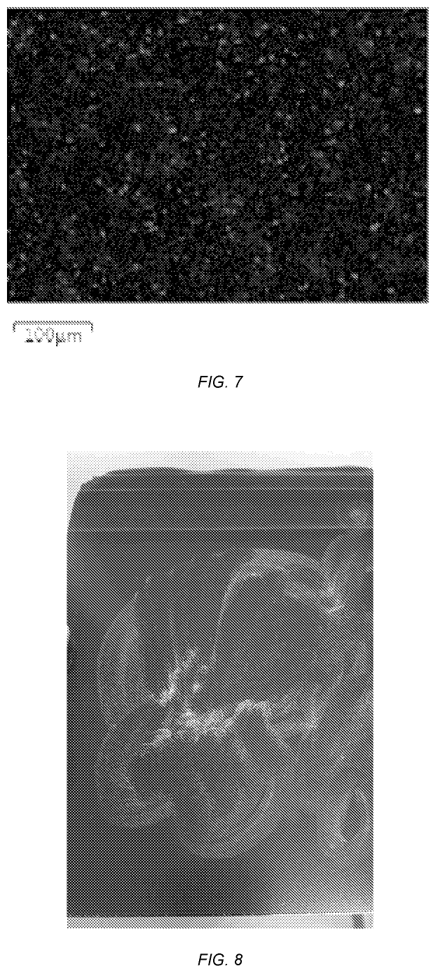

FIG. 5 shows an EDS layered image—a compositional map showing the Fe, Si, S, Al, F, O and C atom distribution of the silicone oil/fluoropolymer coating of FIG. 1. FIG. 6 shows an EDX image (F Kα_{1,2}) of the silicone oil/fluoropolymer coating of FIG. 1, showing the fluorine atoms (grey). The fluoropolymer blooming effect is clearly visible. FIG. 7 shows an EDX image (Si Kα1) of the silicone oil/fluoropolymer coating of FIG. 1, showing the silicone atoms (grey).

The coating formulation of the present disclosure was developed to overcome the above-mentioned fluoropolymer blooming. Additionally, and beneficially, the coating formulation described herein exhibits the high release performance typical of the silicone oil and at the same time, the long-lasting properties typical of fluoropolymers.

The coating formulation of the present disclosure contains both silicone oil and fluoropolymer, in addition to the further components described further below.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa.

2. Substrates.

Substrates suitable for coating using the coating compositions of the present disclosure may include articles of cookware and, in particular, articles of bakeware. Such articles generally include a circular, rectangular, or square bottom wall, a side wall, and an optional handle or handles. The bakeware articles typically comprise metals or metal alloys such as stainless steel, aluminum, and carbon steel, but may also be a ceramic material, a plastic, or a composite, for example. The bottom and side walls include an interior or food contact surface facing the food to be cooked, as well as an opposite, exterior, or heat contact surface, which, while in use, faces, is adjacent to, or contacts a heat source or heating element. The article of bakeware may include and interior coating and/or an exterior coating over at least a portion of its respective interior and/or exterior surfaces, including at least a portion of, or all of, the bottom wall and/or side walls.

Bakeware and other products for use at high temperatures are manufactured from a pre-coated metal substrate that may be pressed, stamped or drawn into a desired shape. The substrate may be pre-coated to avoid the need to apply a coating to the formed product, which can result in a non-uniform coated finish.

When used in cookware or bakeware applications, coatings formed from the present coating compositions are highly heat resistant though, as discussed in further detail below, may also have a decorative function and may include one or more pigments or other additives to provide a visually aesthetic color.

The present coating compositions may also be used to coat non-cookware articles, such as rollers, molds, conduits and fasteners, which require a non-stick or release property and/or which are exposed to heat in use.

3. Types of Coating Compositions.

The present coating compositions may be a topcoat, i.e., an exterior-most or exteriorly exposed coating, which either may be applied directly to the outer surface of the substrate article or alternatively, may be applied over one or more underlying coatings, or undercoats. For example, one undercoat may be a primer, which is applied directly to the outer surface of the substrate article, with the present coating applied over the primer. The present coating compositions may also form part of a coating system which includes a primer together with a midcoat applied over the primer, with the present coating composition applied over the midcoat. Further, the primer layer may include one or more distinct, separately-applied layers, and the midcoat may also include one or more distinct, separately-applied layers.

Fluoropolymer and silicone oil comprise a formulation which may be applied onto a substrate in the form of a coating. The coating formulation of the present disclosure may be applied directly to the substrate, over a basecoat, or as a topcoat over a basecoat and midcoat. Alternatively, the formulation may be applied as the topcoat in a two-coat system, wherein the basecoat is applied to provide anti-corrosive, barrier or visual properties.

4. PTFE Fluoropolymers.

The fluoropolymers for use in the coating formulations of the present disclosure may be polytetrafluoroethylene (PTFE), perfluoroalkoxy polymer (PFA), and/or fluorinated ethylene propylene (FEP), or one or more fluoropolymers, such as one or more PTFE polymers, for example. One type of PTFE or multiple types of PTFE may be used in the formulation, as discussed below.

The molecular weight of a polymer may be described in different ways. One manner by which it may be defined is the number average molecular weight (Mn). This measurement is defined as the average mass of macromolecules in a given polymer sample, as determined by dividing the sum of the molecular masses of individual macromolecules by the number of molecules present. Alternatively, the molecular weight of the polymer may be defined by the weight average molecular weight (Mw). This calculation is based on the weight fraction represented by each type of polymer molecule in the sample. The Mn statistic is weighted more towards lower molecular weight polymers in the sample, while the Mw represents the midpoint of the distribution in terms of the number of molecules.

The Mw of the of the polytetrafluoroethylene (PTFE) polymers of the present disclosure is about 250,000 g/mol or greater, about 275,000 g/mol or greater, about 300,000 g/mol or greater, about 325,000 g/mol or greater, about 350,000 g/mol or lower, about 375,000 g/mol or lower, about 400,000 g/mol or lower, about 450,000 g/mol or lower, about 500,000 g/mol or lower, or within any range encompassing these endpoints.

The Mw of the perfluoroalkoxy (PFA) polymers of the present disclosure is about 600,000 g/mol or greater, about 650,000 g/mol or greater, about 700,000 g/mol or greater, about 750,000 g/mol or greater, about 800,000 g/mol or greater, about 850,000 g/mol or lower, about 900,000 g/mol or lower, about 950,000 g/mol or lower, about 1,000,000 g/mol or lower, or within any range encompassing these endpoints.

The melting point of the fluorinated ethylene propylene (FEP) polymers of the present disclosure is 220° C. or greater, 225° C. or greater, 230° C. or greater, 235° C. or greater, 240° C. or lower, 245° C. or lower, 250° C. or lower, 255° C. or lower, 260° C. or lower, or within any range encompassing these endpoints as measured by ASTM D5675.

The weight average molecular weight of the fluoropolymer may be determined using melt flow index (MEI) analysis. In MFI testing, the fluoropolymer is not dissolved in a solvent but rather is tested in the melted state.

The MFI for perfluoroalkoxy polymer (PFA) micropowder may be 4 g/10 min or greater, 5 g/10 min or greater, 6 g/10 min or greater, 7 g/10 min or greater, 10 g/10 min or less, 20 g/10 min or less, 30 g/10 min or less, 50 g/10 min or less, 70 g/10 min or less, or within any range encompassing these endpoints as measured using the method described in ASTM D1238.

The MFI for fluorinated ethylene propylene (FEP) may be 1 g/10 min or greater, 3 g/10 min or greater, 5 g/10 min of greater, 10 g/10 min or greater, 20 g/10 min greater, 30 g/10 min or less, 40 g/10 min or less, 50 g/10 min or less, 60 g/10 min or less, 70g/10 min or less, or within any range encompassing these endpoints as measured using the method described in ASTM D3159.

The MFI for polytetrafluoroethylene (PTFE) may be 3 g/10 min or greater, 4 g/10 min or greater, 5 g/10 min or greater, 6 g/10 min or greater, 7 g/10 min or greater, 8 g/10 min or less, 9 g/10 min or less, 10 g/10 min or less, 11 g/10 min or less, 12 g/10 min or less, 13 g/10 min or less as measured using the method described in DIN EN ISO 1133.

The MFI has a direct correlation to the polymer's melt viscosity. For polymer melts, the viscosity at very low shear rates (zero-share viscosity) has a relationship to the weight averaged-molecular weight (the total weight of the polymer divided by the total number of molecules) as determined by equation 1, below.

h₀=KM_{w}ⁿ Equation 1:

where h₀ is the zero-share viscosity, K is a constant that is specific to the polymer being assessed and the exponent n is a number whose values lie within the range of 3.2 -4.6. Given the inverse relationship between MFI and viscosity, the MFI has a relationship to the molecular weight as follows: 1/MFI=h₀=KM_{w}ⁿ.

The fluoropolymers of the present disclosure are substantially free of high molecular weight PTFE, defined herein as having a weight average molecular weight (Mw) of greater than 1,000,000 g/mol. In other words, high molecular weight PTFE is included in the fluoropolymers of the present disclosure in an amount of 0.5 wt. % of less, 0.1 wt. % or less, or 0.05 wt. % or less based on the total weight of the fluoropolymer.

The fluoropolymers used in the present disclosure are not fluorotelomers. In other words, the fluoropolymers of the present disclosure include fluorotelomers, if present at all, in amounts of 0.5 wt. % of less, 0.1 wt. % or less, or 0.05 wt. % or less based on the total weight of the fluoropolymer. The fluoropolymers of the present disclosure are not produced by a telomerisation process. That is, the fluoropolymers of the present disclosure are not prepared by combining a fluoroalkene, and optionally, a comonomer, in a hydrofluorocarbon solvent with a free radical initiator and at least one secondary alcohol or derivative thereof.

The fluoropolymers of the present disclosure are substantially free of reactive, cross-linkable groups such as endgroups comprising secondary alcohols or their derivatives. In other words, the fluoropolymers of the present disclosure include fluoropolymers with reactive, cross-linkable groups in an amount of 0.1 wt. % or less, based on the total weight of the fluoropolymer.

The fluoropolymers of the present disclosure, such as polytetrafluoroethylene PTFE), may be included in the formulation as fluoropolymer micropowders. To form the micropowders, the fluoropolymer may be exposed to thermal degradation, typically in a twin-screw extruder, to provide a low molecular weight fluoropolymer. Following thermal treatment, the fluoropolymer may be micronized, or pulverized, to reduce the particle size of the fluoropolymer particles and produce a micropowder. Suitable micronizers include impact micronizers and grinding micronizers. Examples of suitable impact micronizers may include hammer mills, pin mills, and jet mills. Examples of suitable grinding micronizers may include cutter mills.

A jet mill may be used to form the micropowder. Jet mills use high speed jets comprising compressed air or inert gas to impact particles together. Particles of a certain size or smaller may comprise the output of the mill, while larger particles continue to be milled. Thus, jet milling may be used to produce a narrow size distribution of milled particles.

Following micronization, the average size of the micropowder particles may be 3 microns or larger, 5 microns or larger, 4 microns or larger, 5 microns or larger, 6 microns or smaller, 7 microns or smaller, 8 microns or smaller, 9 microns or smaller, or within any range encompassing these endpoints. The particle size may be determined by the methods described in ISO 13321, for example.

The bulk density of the micropowder may be 250 g/L or greater, 275 g/L or greater, 300 g/L or greater, 325 g/L or less, 350 g/L or less, 375 g/L or less, 400 g/L or less, or within any range encompassing these endpoints. The bulk density may be determined by the methods described in ASTM D4895 or ASTM D5675, for example.

The specific surface area (BET) of the micropowder may be 2 m²/g or greater, 3 m²/g or greater, 4 m²/g or greater, 5 m²/g or greater, 6 m²/g or less, 7 m²/g or less, 8 m²/g or less, 9 m²/g or less, 10 m²/g or less, or within any range encompassing these endpoints. The specific surface area may be determined by the methods described in DIN 66132, for example.

The melting peak temperature of the micropowder may be 300° C. or greater, 310° C. or greater, 325° C. or lower, 335° C. or lower, 345° C. or lower, or within any range encompassing these endpoints. The melting peak temperature may be determined using the methods described in ASTM D4591-97, for example.

The melt flow rate of the micropowder may be 5 g/10 min or greater, 7 g/10 min or greater, 9 g/10 min or greater, 10 g/10 min or lower, 12 g/10 min or lower, 14 g/10 min or lower, 15 g/10 min or lower, or within any range encompassing these endpoints. The melt flow rate may be determined by the methods described in ISO 1133, for example.

The amount of per- and poly-fluoroalkyl species present in the fluoropolymer or fluoropolymer micropowder may be determined by liquid chromatography-tandem mass spectrometry (LC-MS/MS), which may be practiced using isotope dilution. The dry limit of quantification (LOQ) may be less than 1.0 parts per billion (ppb).

The total amount of perfluorooctanoic acid (PFOA) present in the micropowder may be 25 parts per billion (ppb) or less, 20 ppb or less, 15 ppb or less, 10 ppb or less, or 5 ppb or less.

The total amount of C4-C16 per/polyfluorocarboxylic acids present in the micropowder may be 25 parts per billion (ppb) or less, 20 ppb or less, 15 ppb or less, 10 ppb or less, or 5 ppb or less.

The total amount of C9-C14 per/polyfluorocarboxylic acids present in the micropowder may be 25 parts per billion (ppb) or less, 20 ppb or less, 15 ppb or less, 10 ppb or less, or 5 ppb or less.

The total amount of C6 per/polyfluorocarboxylic acids present in the micropowder may be 25 parts per billion (ppb) or less, 20 ppb or less, 15 ppb or less, 10 ppb or less, or 5 ppb or less.

Additionally, the total combined amount of perfluorooctanoic acid (PFOA), C4-C16 per/polyfluorocarboxylic acids, C9-C14 per/polyfluorocarboxylic acids, and C6 per/polyfluorocarboxylic acids present in the micropowder may be 25 parts per billion (ppb) or less, 20 ppb or less, 15 ppb or less, 10 ppb or less, or 5 ppb or less.

While the foregoing thresholds for perfluorooctanoic acid (PFOA) and per/polyfluorocarboxylic acids are provided for the fluoropolymer micropowder, the same thresholds for the amounts of perfluorooctanoic acid (PFOA) and per/polyfluorocarboxylic acids also apply to the total or overall coating composition.

The fluoropolymer may be introduced into the formulation in the form of micropowder. The micropowder may be included in the coating composition of the present disclosure in the form of a dispersion in a resin, or the micropowder may be added as the micropowder alone. As discussed further below, a first portion of the fluoropolymer micropowder may be added in the form of a dispersion, while a second portion of the fluoropolymer micropowder may be added as the micropowder alone.

The micropowder may be dispersed in a binder resin, such as a polyethersulfone (PES) resin (as shown in the Tables below), namely in the form of PTFE micropowder, perfluoroalkoxy polymer (PFA) micropowder, and/or fluorinated ethylene propylene (FEP) micropowder.

Table 1 below shows the main physical data for an example PFTE micropowder.

TABLE 1

| Property | Test Method | |
|---|---|---|
| Appearance | Visual | White |
| Melt Point Temperature (° C.) | DSC | 323 ± 5.0 |
| Particle Size (D50) (Microns) | Laser | 3.0 ± 1.5 |
| | Diffraction | |
| Maximum Particle size (D90) | Laser | ≤7.0 |
| (Microns) | Diffraction | |

Exemplary properties of a PFA micropowder are shown below in Table 2.

TABLE 2

| Property | Test Method | |
|---|---|---|
| Melting point (° C.) | DSC | 308 |
| Specific gravity | ASTM D792 | 2.1 |
| Coefficient of water absorption | ASTM D570 | <0.03 |
| (%) | | |
| Melt flow rate (g/10 min) | ASTM D3307 | 7-18 |

Exemplary main physical data for the fluorinated ethylene propylene (FEP) micropowder are shown below in Table 3.

TABLE 3

| | Unit of | | |
|---|---|---|---|
| Property | Measure | Test Method | |
| Appearance | | Visual | White |
| Melt Point Temperature | ° C. | DSC | 240 ± 9.0 |
| Particle Size (D50) | Microns | Laser Diffraction | 4.0 ± 1.5 |
| Maximum Particle size | Microns | Laser Diffraction | <12 |
| (D90) | | | |
| Melt Flow Index (MFI) | g/10 min | 2.06 kg Weight | 35-70 |

5. Binder Resins.

A wide array of binder resins may be blended with the fluoropolymers. The main functions of binder resins in the present coatings is to provide adhesion to the substrate, to improve the barrier properties, and to enable pigment dispersion. The binder resin is referred to herein interchangeably as a ‘binder’, ‘resin binder’ or ‘binder resin’, ‘resin bulk’, ‘base’, or ‘binder system’ and provides the bulk of the present coatings when applied to a substrate.

Binder resins may be distinguished by the temperature at which they are processed. More specifically, a distinction may be drawn between binder resins processed above the melting temperature of the fluoropolymer and binder resins that are processed below the melting temperature of the fluoropolymer. Typically, favorable properties may be achieved for binder resins processed at a temperature above the melting point of the fluoropolymer.

Another important distinction that can be made among binder resins used in fluoropolymer coatings is between thermosetting resins and thermoplastic resins. In particular, thermosetting resins undergo a permanent chemical reaction during the curing process that may be initiated by light, heat, air or moisture, for example, which introduce cross-links between the resin molecules to increase the chemical resistance, hardness and impact resistance of the resulting coating. Furthermore, the coating cannot be re-dissolved in its original solvent. Thermoplastic binders, by contrast, do not undergo chemical reaction to form crosslinks but rather create a film by melting and flowing out over the substrate.

Among the high-performance polymers suitable for use as binders in fluoropolymer coatings of the present disclosure, polyamide-imide (PAI), polyethersulfone (PES), polyphenylsulfone (PPSU), and polysulfone (PSU) resins are the most widely used for bakeware. These amorphous thermoplastic polymers exhibit high temperature resistance and chemical resistance. Even though these polymers are tough and hard, they provide a high degree of flexibility, thus allowing forming, by pressing or drawing, of prior-coated substrates during the bakeware forming, as discussed further below.

The distribution of molecular weights in a polymer sample may be described by the weight average molecular weight (Mw), defined as the total weight of the polymer sample divided by the total number of the molecules in the sample. The binder resins for use in the present coating compositions may have a weight average molecular weight of 16,500 g/mol or greater, 20,000 g/mol or greater, 25,000 g/mol or greater, 30,000 g/mol or greater, 35,000 g/mol or greater, 40,000 g/mol or greater, 42,000 g/mol or greater, 45,000 g/mol or greater, 50,000 g/mol or less, 55,000 g/mol or less, 60,000 g/mol or less, 65,000 g/mol or less, or within any range encompassing these endpoints, as determined by ASTM D5296.

The resin base may be prepared by dispersing a solid resin in a solvent or solvent blend, as further described below. The solid resin may be dispersed in the solvent in an amount of 20 wt. % or greater, 22 wt. % or greater, 24 wt. % or greater, 26 wt. % or less, 28 wt. % or less, 30 wt. % or less, or within any range encompassing these endpoints, based on the total weight of solvent and resin in the dispersion.

The solvent or solvent blend is described further below. The same solvent or solvent blend may be used across the entire formulation to keep the resin base in solution. This may help to ensure the optimal stability of the resin base and increase pot life.

6. Hydroxyl-Modified Silicone Resin.

A hydroxy-functional silicone resin, (also referred to herein as ‘silicone resin’) may be included in the present coating composition. Suitable hydroxy-functionalized silicone resins may include phenyl silicone, methyl silicone, and methyl phenyl silicone, for example. This silicone resin is believed to function as a bridging element to allow the establishment of an equilibrium between the silicone oil and the fluoropolymer and provide compatibility between the silicone oil and the fluoropolymer to mitigate or substantially eliminate fluoropolymer blooming in the present coatings.

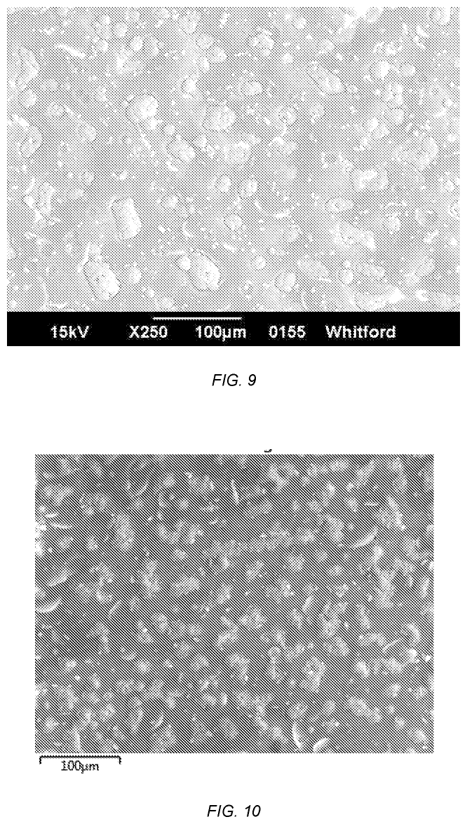

When the silicone resin is included in the coating formulation, as in the formulations of the present disclosure, the fluoropolymer blooming described above may be avoided, as shown in FIG. 6 and FIG. 9, which show the coating after curing.

The hydroxy-functional silicone resin used herein may be non-moisture curable. The silicone resin may comprise only hydroxyl groups as reactive functional groups. The silicone resin may further comprise other reactive substituents, such as methoxy, carboxy or amino groups in amounts of 1 wt. % or lower, 0.5 wt. % or lower, or 0.1 wt. % or lower. These amounts are sufficiently low so as not to render the silicone resin moisture curable.

The hydroxy-functional silicone resin may be functionalized with a substituted or unsubstituted aryl, alkyl, or arylalkyl group. The silicone resin may be a cross-linked organosiloxane, for example, the silicone resin may be an organosiloxane of the general formula shown below:

RₙSiXₘO_{y}

wherein each R is, independently, substituted or unsubstituted aryl, alkyl, or arylalkyl; X is hydroxyl; and n, m and y are the relative stoichiometries of R, X and O.

‘Aryl’ is selected from a C₅₋₈ aryl group, with 0, 1 or 2 heteroatoms selected from O, N or S. The aryl group may be unsubstituted or substituted with 1 or 2 groups independently selected from methyl, ethyl, propyl, iso-propyl, or a halo group, such as Cl, Br, I, and F. The aryl group may be phenyl. The aryl group may be substituted with one methyl group.

‘Alkyl’ is selected from C₁₋₈ alkyl group and may be straight chain, branched, or a C₃₋₈ cycloalkyl group. For example, the alkyl group may be methyl or ethyl.

‘Arylalkyl’ is selected from a C₅₋₈ aryl group, substituted with 1 or 2 alkyl groups. The alkyl group may be independently selected from methyl or ethyl. For example, the arylalkyl group may be methyl phenyl.

The hydroxy-functional silicone resin may be selected from one or more of phenyl silicone, methyl silicone, methyl phenyl silicone, or any combination thereof.

The hydroxy-functional silicone resin may have a weight average molecular weight (M_{w}) of greater than 1500 g/mol, greater than 1500 g/mol, greater than 3000 g/mol, less than 3500 g/mol, less than 4000 g/mol, less than 4500 g/mol, or a range between any two of these amounts. For example, the hydroxy-functional silicone resin may have a weight average molecular weight (M₂) of 2500-4000 g/mol, 1500-4500 g/mol, or 3000-3500 g/mol. The molecular weight of the resin may be determined by gel permeation chromatography (GPC) analysis with polystyrene standard, as described in DIN Standard 55672.

A hydroxy-functional silicone resin solution may be prepared by dissolving the silicone hydroxy-functional resin in a suitable fluid such as Solvesso™ 100 aromatic fluid, available from ExxonMobil Chemical. Alternatively, the silicone hydroxy-functional resin may be dissolved in a solvent blend comprising dimethyl sulfoxide, gamma butyrolactone, and cyclohexanone, as described further below. The resulting resin solids content may be 40 wt. % or greater, 50 wt. % or greater, 60 wt. % or greater, 70 wt. % or lower, 80 wt. % or lower, or within any range encompassing these endpoints, as based on the total weight of the resin and solvent.

One suitable hydroxy-functional silicone may be available in a flake form. This form may be solubilized for use in the compositions of the present disclosure. The silicone may be a 100% hydroxy-functional phenyl silicone flake is used as a binder for powder and liquid coatings. The hydroxyl content of the hydroxy-functional silicone flake may be 4 wt. % or greater, 5 wt. % or greater, 6 wt. % or lower, 7 wt. % or lower, 8 wt. % or lower, or within any range encompassing these endpoints.

The hydroxy content of the hydroxy-functional silicone resin may be 4 wt. % or greater, 5 wt. % or greater, 6 wt. % or lower, 7 wt. % or lower, 8 wt. % or lower, or within any range encompassing these endpoints, based on the total weight of the hydroxy-functional silicone resin. The hydroxy groups may be located on tertiary “T” units (e.g., (OH)SiO₃) of the silicone resin.

The glass transition temperature (Tg) of the hydroxy-functional silicone may be 55° C. or greater, 60° C. or greater, 62° C. or greater, 64° C. or greater, 66° C. or less, 68° C. or less, 70° C. or less, 75° C. or less, or withing any range encompassing these endpoints. The glass transition temperature (Tg) may be measured using a penetrometer. Briefly, a sample is placed in a quartz housing blanketed with dry nitrogen. A free-floating quartz rod rests on the sample while the sample chamber is heated at a specified rate (typically 1° C./minute). As the sample softens, the displacement of the rod from its initial position increases. The temperature at which the displacement reaches a specified value (typically 0.012 mm) is reported as the softening point.

The melt viscosity of the hydroxy-functional silicone at 107° C. (225° F.) may be 85,000 cP or greater, 87,000 cP or greater, 90,000 cP or greater, 92,000 cP or less, 95,000 cP or less, 98,000 cP or less, 100,000 cP or less, or within any range encompassing these endpoints, as determined by ASTM D-3236. The melt viscosity of the hydroxy-functional silicone at 150° C. (302° F.) may be 1300 cP or greater, 1350 cP or greater, 1390 cP or greater, 1410 cP or less, 1430 cP or less, 1450 cP or less, 1500 cP or less, or within any range encompassing these endpoints, as determined by ASTM D-3236.

The flash point (closed cup) of the hydroxy-functional silicone may be 130° C. or greater, 135° C. or greater, 138° C. or less, 140° C. or less, 145° C. or less, or within any range encompassing these endpoints, as determined by ASTM D56.

The formulation is viscosity stable and provides the desired properties when the ratio

$$\frac{phenyl silicone hydroxy functional resin}{polyethersulphone resin} is between 15 \% and 30 \% .$$

The ratio referred to is phenyl silicone hydroxy functional resin and polyethersulfone resin on resin solids, meaning that the ratio refers to the dry polymer weight without the solvent.

A formulation tested and found to deliver the same properties as the formulation above was ratio:

$$\frac{phenyl silicone hydroxy functional resin}{polyethersulphone resin} = 20 \%$$

A further stable formulation tested had the following ratio:

$$\frac{phenyl silicone hydroxy functional resin}{polyethersulphone resin} = 19 \%$$

The ratio of phenyl silicone hydroxy functional resin to polyethersulfone resin may be 15% or higher, 17% or higher, 20% or higher, 22% or lower, 25% or lower, 30% or lower, or within any range encompassing these endpoints.

These ratios also apply to alternative resin binder systems, such as PAI, PPSU and PSU, and alternative silicone resins, such as hydroxy functional methyl silicone resin and hydroxy functional methyl phenyl silicone resin.

7. Silicone Oil.

The silicone oil surrounds the fluoropolymer droplets on the coating surface, this effect is clearly visible from the scanning electron microscope (SEM) and EDX images, for example, shown in FIGS. 8, 11, 12, 13, and 14.

The silicone oil may be present in a relatively small amount and may, therefore, be considered as an additive. A coating formulation disclosed herein comprises a coating composition as described herein and a resin binder, and may optionally comprise one or more additional solvents, additives and/or components (such as a flow additive and/or pigment).

The silicone oil may be a non-reactive and non-moisture curable fluid. Suitable silicone oils may be a polydialkylsiloxanes, which are polymers comprising a repeat unit of the general formula shown below:

-[—O—Si(R′)₂—]-

wherein R′ is an alkyl group, for example a C₁₋₈ alkyl group. The polymer may comprise any suitable termination group, such as a —Si(R′)₃ group.

The viscosity of the oil at 25° C. may be 50 cS or greater, 100 cS or greater, 200 cS or greater, 300 cS or greater, 400 cS or greater, 500 cS or greater, 600 cS or less, 700 cS or less, 800 cS or less, 900 cS or less, 1000 cS or less, or within any range encompassing these endpoints, as determined by ASTM D 1084 Method B (for cup/spindle) and ASTM D 4287 (for cone/plate). An exemplary silicone oil is linear polydimethylsiloxane having kinematic viscosity of 100 cS at 25° C.

In appearance, the silicone oil may be a clear to slightly hazy liquid, the color of which may be 0 or greater, 5 or greater, 10 or greater, 15 or greater, 20 or greater, 25 or less, 30 or less, 35 or less, 40 or less, or within any range encompassing these endpoints, as measured by ASTM D1209.

The silicone fluid included in the formulations of the present disclosure may be a polydimethylsiloxane. The polydimethylsiloxane may not include hydroxyl groups. Specifically, the hydroxyl content of the polydimethylsiloxane may be 2.5 wt. % or less, 2.0 wt. % or less, 1.5 wt. % or less, or 1.0 wt. % or less, based on the total weight of the silicon oil. The hydrochloric acid content may be 1.0 ppm or less, 0.5 ppm or less, or 0 ppm.

8. Additives.

The composition may include one or more additives. Such additives may include pigments, such as aluminum pigments and carbon black pigments; coating reinforcers, such as silicon carbide and aluminum oxide, for example; flow agents, such as a polymeric non-silicone flow additive, e.g. Dynoadd® F-1, F-101 obtained from Dynea AS; and matting agents, for example.

Carbon black pigment may be dispersed in the binder. The carbon black pigment is milled in the resin medium with suitable milling equipment until the average particle size dimension is less than 10 microns. The particles may then be dispersed in the binder, such as a polyethersulfone resin.

9. Solvents.

Various solvents and solvent blends may be used to solubilize the binder resins, though the same solvent or solvent blend may be used across the entire formulation. Solubility may be explained using the Hansen solubility parameter approach described in Hansen C. M. 15 Jun. 2007. Hansen Solubility Parameters: A User's Handbook. Second CRC Press, Science, the entire contents of which are incorporated herein by reference. The Hansen theory defines three parameters used to describe the major types of interactions found in common organic materials such as polymers and solvents. These parameters are correlated to the dispersive interactions, the polar cohesive energy (e.g. permanent dipole-permanent dipole forces) and the hydrogen bonding cohesive energy existing within the organic material.

The three parameters are frequently considered and combined in the classic formula for Hansen solubility parameters (HSP) where the total parameter δ is broken into δ_{d}, δₚ and δ_{H} for dispersion interactions (d), polar cohesive energy (p) and hydrogen-bonding cohesive energy (h):

δ²=δ_{d}²+δₚ²+δₕ²

The units of the solubility parameters are MPa½. The more similar the solubility parameters of two substances are, the greater will be the solubility between them, sometimes referred to in the art as “like dissolves like”.

Another important aspect of the Hansen solubility parameters is that they can be plotted in a 3-dimensional space known as the Hansen space. To determine if two materials (such as a polymer and a solvent) are likely to dissolve into each other, the distance (Rₐ) between the Hansen parameters is evaluated. Rₐ provides a measure of how alike the two materials are from a cohesive energy point of view. The smaller Rₐ, the more likely the materials are to be compatible. The formula used to define Rₐ is the following:

Rₐ²=4(δ_{d1}−δ_{d2})²+(δₚ₁−δₚ₂)²+(δₕ₁−δₕ₂)²

Wherein 1 and 2 are the materials under evaluation (solvent-polymer or solvent blend-polymer), and d, p and h are as defined above.

Solvents blends are frequently used in the industry to lower the Rₐ value (solvent blend-polymer) to an extent where resin solubility occurs. Polyethersulfone resins have been successfully dissolved in solvent blends where the Rₐ value is 6.5 units.

Formulations containing different solvent blends were prepared. These formulations were developed to meet market demand for N-methyl-2-pyrrolidone-free products. The solvents and solvent blends of the present disclosure may be substantially free of N-methyl-2-pyrrolidone, wherein “substantially free” of N-methyl-2-pyrrolidone means that the solvents and solvent blends of the present disclosure include N-methyl-2-pyrrolidone in an amount of 100 ppm or less, 100 ppb or less, 50 ppb or less, or 10 ppb or less.

The solvent blend shown in Table 4 below provides excellent results in terms of resin stability. N-methyl-2-pyrrolidone (NMP) and gamma butyrolactone are good solvents for polyethersulfone resins. The diluent Solvesso™ 100 (aromatic fluid) may also be introduced into the blend.

TABLE 4

| Solvent Blend 1 | Wt. % |
|---|---|
| N-methyl-2-pyrrolidone (NMP) | 30-50 |
| Solvesso ™ 100 (aromatic fluid) | 20-40 |
| Gamma butyrolactone | 10-30 |

The solvent blend may comprise NMP in an amount of 30 wt. % or greater, 35 wt. % or greater, 40 wt. % or lower, 45 wt. % or lower, 50 wt. % or lower, or within any range encompassing these endpoints.

The solvent blend may comprise Solvesso™ 100 in an amount of 20 wt. % or greater, 25 wt. % or greater, 30 wt. % or lower, 35 wt. % or lower, 40 wt. % or lower, or within any range encompassing these endpoints.

The solvent blend may comprise gamma butyrolactone in an amount of 10 wt. % or greater, 15 wt. % or greater, 20 wt. % or lower, 25 wt. % or lower, 30 wt. % or lower, or within any range encompassing these endpoints.

Additional solvent blends tested are set out in Tables 5 and 6, below.

TABLE 5

| Solvent Blend 2 | Wt. % |
|---|---|
| 3-Methoxy-N,N-dimmethylpropanamide | 1-5 |
| Gamma butyrolactone | 45-60 |
| Cyclohexanone | 40-55 |

TABLE 6

| Solvent Blend 3 | Wt. % |
|---|---|
| Dimethyl sulfoxide | 1-5 |
| Gamma butyrolactone | 45-60 |
| Cyclohexanone | 40-55 |

These solvent blends of the present disclosure may comprise gamma butyrolactone, cyclohexanone, and one of dimethyl sulfoxide and 3-methoxy-N,N-dimethylpropanamide. Gamma butyrolactone may be present in the solvent blend in an amount of 45 wt. % or greater, 50 wt. % or greater, 55 wt. % or lower, 60 wt. % or lower, or within any range encompassing these endpoints. Cyclohexanone may be present in the solvent blend in an amount of 40 wt. % or greater, 45 wt. % or greater, 50 wt. % or lower, 55 wt. % or lower, or within any range encompassing these endpoints. Dimethyl sulfoxide or 3-methoxy-N,N-dimethylpropanamide may be present in the solvent blend in an amount of 1 wt. % or greater, 2 wt. % or greater, 3 wt. % or greater, 4 wt. % or lower, 5 wt. % or lower, or within any range encompassing these endpoints.

10. Coating Compositions.

The coating composition of the present disclosure may include a fluoropolymer component, such as polytetrafluoroethylene (PTFE). The fluoropolymer component may be incorporated in the formulation in micropowder form, as described above. The fluoropolymer micropowder may be dispersed in the binder to form a micropowder dispersion, or the fluoropolymer micropowder may be added to the formulation as the micropowder alone. Alternatively, a first portion of the fluoropolymer micropowder may be added to the formulation as a dispersion and a second portion of the fluoropolymer micropowder may be added as the micropowder alone.

The total amount of the fluoropolymer micropowder in the liquid or “wet” coating composition may be 0.1 wt. % or greater, 0.5 wt. % or greater, 1 wt. % or greater, 5 wt. % or lower, 6 wt. % or lower, 8 wt. % or lower, 10 wt. % or lower, or within any range encompassing these endpoints. The total amount of the fluoropolymer micropowder in the final, applied and cured or “dry” coating may be 2 wt. % or greater, 5 wt. % or greater, 8 wt. % or greater, 10 wt. % or greater, 12 wt. % or lower, 15 wt. % or lower, 18 wt. % or lower, 20 wt. % or lower, or within any range encompassing these endpoints.

The fluoropolymer micropowder dispersion may be present in the liquid or “wet” coating composition in an amount of 1.0 wt. % or greater, 1.5 wt. % or greater, 2 wt. % or greater, 3.0 wt. % or greater, 5.0 wt. % or greater, 6.0 wt. % or greater, 7.0 wt. % or lower, 10 wt. % or lower, 15 wt. % or lower, 20 wt. % or lower, 25 wt. % or lower, 30 wt. % or lower, 35 wt. % or lower, or within any range encompassing these endpoints. The fluoropolymer micropowder dispersion may be present in the final, applied and cured, or “dry” coating in an amount of 4 wt. % or greater, 6 wt. % or greater, 8 wt. % or greater, 10 wt. % or greater, 14 wt. % or greater, 18 wt. % or greater, 20 wt. % or lower, 25 wt. % or lower, 30 wt. % or lower, 35 wt. % or lower, 40 wt. % or lower, 45 wt. % or lower, or within any range encompassing these endpoints. The solids content in the fluoropolymer dispersion may be 90 wt. % or greater, 95 wt. % or greater, 99 wt. % or greater, or 100 wt. %.

The fluoropolymer micropowder component may be present in the liquid or “wet” coating composition in an amount of 0.1 wt. % or greater, about 0.5 wt. % or greater, about 1.0 wt. % or less, about 1.5 wt. % or less, or within any range encompassing these endpoints. The fluoropolymer component may be present in the final, applied and cured, or “dry” coating in an amount of about 0.5 wt. % or greater, about 1.0 wt. % or greater, about 1.5 wt. % or greater, about 2.0 wt. % or lower, about 2.5 wt. % or lower, about 3.0 wt. % or lower, or within any range encompassing these endpoints. The solids content of the fluoropolymer micropowder may be 90 wt. % or greater, 95 wt. % or greater, 99 wt. % or greater, or 100 wt. %.

The coating composition of the present disclosure may include a binder, such as polyamide-imide (PAI), polyethersulfone (PES), polyphenylsulfone (PPSU), and polysulfone (PSU), or a combination of one or more of these. The total amount of binder may be present in the liquid or “wet” coating composition in an amount of 10 wt. % or greater, 11 wt. % or greater, 12 wt. % or greater, 13 wt. % or greater, 14 wt. % or greater, 15 wt. % or greater, 16 wt. % or greater 17 wt. % or greater, 18 wt. % or greater, 19 wt. % or less, 20 wt. % or less, 21 wt. % or less, 22 wt. % or less, 23 wt. % or less, 24 wt. % or less, 25 wt. % or less, or within any range encompassing these endpoints. The binder may be present in the final, applied and cured, or “dry” coating in an amount of 50 wt. % or greater, 55 wt. % or greater, 60 wt. % or greater, 65 wt. % or less, 70 wt. % or less, 75 wt. % or less, 80 wt. % or less, 85 wt. % or less, or within any range encompassing these endpoints. The solids content of the binder may be 90 wt. % or greater, 95 wt. % or greater, 99 wt. % or greater, or 100 wt. %.

The coating composition of the present disclosure may include a hydroxy-functionalized silicone resin. The hydroxy-functionalized silicone resin may be present in the liquid or “wet” coating composition in an amount of 2 wt. % or greater, 3 wt. % or greater, 4 wt. % or greater, 5 wt. % or lower, 6 wt. % or lower, 7 wt. % or lower, or within any range encompassing these endpoints. The hydroxy-functionalized silicone resin may be present in the final, applied and cured, or “dry” coating in an amount of 9 wt. % or greater, 10 wt. % or greater, 11 weight percent or greater, 12 wt. % or lower, 13 wt. % or lower, 14 wt. % or lower, or within any range encompassing these endpoints. The solids content of the hydroxy-functionalized silicone resin may be 90 wt. % or greater, 95 wt. % or greater, 99 wt. % or greater, or 100 wt. %.

The coating composition of the present disclosure may include a silicon oil. The silicone oil may be present in the liquid or “wet” coating composition in an amount of 0.1 wt. % or greater, 0.3 wt. % or greater, 0.5 wt. % or greater, 0.7 wt. % or lower, 0.9 wt. % or lower, 1.0 wt. % or lower, or within any range encompassing these endpoints. The silicone oil may be present in the final, applied and cured, or “dry” coating in an amount of 0.5 wt. % or greater, 0.7 wt. % or greater, 0.9 weight percent or greater, 1.0 wt. % or lower, 1.2 wt. % or lower, 1.4 wt. % or lower, 1.6 wt. % or lower, 1.8 wt. % or lower, 2.0 wt. % or lower, 2.5 wt. % or lower, or within any range encompassing these endpoints.

The liquid or “wet” coating composition of the coating composition of the present disclosure may comprise a solvent or blend of solvents, such as a blend of dimethyl sulfoxide, gamma butyrolactone, and cyclohexanone. The solvent or blend of solvents may be present in the wet formulation in an amount of 50 wt. % or greater, 55 wt. % or greater, 60 wt. % or greater, 65 wt. % or greater, 70 wt. % or lower, 75 wt. % or lower, 80 wt. % or lower, 85 wt. % or lower, 90 wt. % or lower, or within any range encompassing these endpoints.

The coating composition of the present disclosure may include one or more additives, such as pigments, flow additives, matting agents, and coating reinforcements, for example. The additives may be present in the liquid or “wet” coating composition in an amount of 0.01 wt. % or greater, 0.1 wt. % or greater, 0.2 wt. % or greater, 0.3 wt. % or greater, 0.4 wt. % or greater, 0.5 wt. % or greater, 1 wt. % or lower, 2 wt. % or lower, 3 wt. % or lower, 4 wt. % or lower, 5 wt. % or lower, or within any range encompassing these endpoints. The additives may be present in the final, applied and cured, or “dry” coating in an amount of 0.5 wt. % or greater, 1 wt. % or greater, 2 wt. % or greater, 3 wt. % or greater, 4 wt. % or greater, 5 wt. % or greater, 6 wt. % or lower, 7 wt. % or lower, 8 wt. % or lower, 9 wt. % or lower, 10 wt. % or lower, 11 wt. % or lower, or within any range encompassing these endpoints.

11. Methods of Preparing the Coating Compositions.

In general, the coating compositions of the present disclosure may be produced by pre-mixing a pigment, such as an aluminum pigment, with a solvent in a first vessel. In a second vessel, a dispersion of a fluoropolymer micropowder, such as a PTFE micropowder in a resin base, such as a polyethersulfone resin base, may be combined with a resin base, such as a polyethersulfone resin base, and a pigment, such as a carbon black pigment, dispersed in a resin base, such as a polyethersulfone resin base. This mixture may then be combined with a flow agent and a reinforcing agent, such as silicon carbide. A fluoropolymer micropowder, such as a PTFE micropowder, may then be added. In a third vessel, a solvent blend, such as those discussed above, may then be combined with silicone oil and a hydroxy-functional resin. The contents of the third vessel may then be combined with those of the second vessel before combining the mixture with the contents of the first vessel. A sample procedure for the formulation of the coating composition is provided below.

In container a first container, premix the aluminum pigment paste and Solvesso™ 100-aromatic fluid for 30-35 minutes. Allow to stand for 12 hours until a smooth aluminum paste is achieved. In a second container, premix the polyethersulfone resin base, PTFE micropowder dispersion in polyethersulfone resin base, and carbon black pigment dispersion in polyethersulfone resin base, and mix at medium speed [e.g. 100-500 rpm] for 10-12 minutes. Add the polymeric non-silicone flow agent to the second container while mixing. Add the silicon carbide to the second container while mixing. Add the PTFE micropowder to the second container and mix at high speed (e.g. 1000-5000 rpm). Premix the solvent blend, silicone oil, and 60% solids phenyl silicone hydroxy functional resin solution in Solvesso™ 100 (aromatic fluid) in a third container, then add to the second container. Gently remix metallic premix prepared in the first container before slowly adding to batch (the second container) under medium speed mixer. Rinse the first container with gamma butyrolactone and add to the second container with mixing.

12. Methods of Applying the Coating Compositions

As described above, the fluoropolymer and silicone oil comprise a formulation which may be applied directly to the substrate, over a basecoat, or as a topcoat over a basecoat and midcoat. Alternatively, the formulation may be applied as the topcoat in a two-coat system.

The formulation may be applied to the substrate by any method known in the art, such as spray coating, curtain coating, or roller coating, coil coating, and bar coating, for example. The coated substrate may then be cured to provide a coated substrate. After application of the one or more coating layers to the substrate surface, the substrate may then be cured and then formed into a desired shape. In particular, a substrate in the form of a substantially flat sheet may be coated by a coating composition of the present disclosure, followed by curing to form a coating. Thereafter, the coated substrate sheet may be bent, drawn, pressed, or otherwise deformed into a final shape with the coating remaining intact.

Coil coating is the roller application of a paint to one or both sides of a moving metal substrate, such as steel. The paint is applied to the surface of the substrate in a continuous process, dried in an oven and the substrate is then re-coiled, resulting in a coil of metal strip with a formable, uniform, functional or decorative coating. Coil coated bakeware is typically Electrolytic Chromium Coated Steel (ECCS steel) with a thickness around 0.28 to 0.8 mm coated with either easy-clean or non-stick coatings usually applied between 6 and 15 μm of dry film thickness (DFT). Bakeware is cold pressed from this coated coil forming a variety of baking tin shapes, such as for bread, cake and roasting. Such a process will deform the metal. The maximum deformation is dependent on the R (Plastic Strain Ratio) and N (Anisotropy — uniformity of stretching) values of the substrate that has been coated. Elongation of the substrate causes stretching of the non-stick coating on the inside corners with a 30-70% reduction of the coating dry film thickness (DFT). The non-stick coating of the bakeware can provide resistance against the attack of various food simulants, but this resistance is reduced after the pressing. Chemical substances play an important role in food production and distribution. ECCS articles for food products are never used without an organic protection layer (lacquer, polymer). The lacquer provides lubrication in the production phase and protection against corrosion.

The coated substrate is then cured in an oven at a temperature of 350° C. or higher, 375° C. or higher, 400° C. or higher, 425° C. or lower, 450° C. or lower, or within any range encompassing these endpoints. The coated substrate may be cured for a period of time of 15 seconds or more, 30 seconds or more, 60 seconds or more, 75 seconds or less, 90 seconds or less, 120 seconds or less, or within any range encompassing these endpoints.

Following curing, the coated substrate may be cooled and coiled or formed directly into an article of a desired shape. The opposite surface of the substrate may be uncoated, or coated with a different coating material, for example, to produce a colored or textured exterior of the article.

In the first stage of the curing process the solvent evaporates leading to film shrinkage. If the curing temperature exceeds the melting point the binder and the fluoropolymer molecules become fluid and intimately mix. A thermodynamically driven process called stratification brings about the creation of a concentration gradient within the coating film: the fluoropolymer migrates to the surface whereas the binder molecules sit on the substrate. The resulting coating exhibits the non-stick properties provided by the high fluoropolymer concentration at the finish surface and in addition to that, the binder properties ensure good adhesion to the substrate.

13. Coating Characteristics.

The coating formulation of the present disclosure may be used in a single layer application. The present coatings are typically applied to a dry film thickness (DFT) of 7 microns or greater, 9 microns or greater, 10 microns or greater, 11 microns or less, 13 microns or less, 15 microns or less, or within any range encompassing these endpoints, depending on the application. A coating formulation of the present disclosure can also be applied via spray application to a final dry film thickness between 7-15 microns. Depending on the specific application desired, the formulation viscosity may be slightly varied.

For a two-coat system, the optimal DFT depends on the specific coating application method. For coil coating, the recommended DFT ranges for the basecoat are 2 microns or greater, 4 microns or less, 5 microns or less, 6 microns or less, or within any range encompassing these endpoints. For the topcoat, the recommended DFT range is 4 microns or greater, 5 microns or greater, 6 microns or greater, 7 microns or less, 8 microns or less, 9 microns or less, 10 microns or less, or within any range encompassing these endpoints. The recommended total DFT is 16 microns or less, 17 microns or less, or 18 microns or less.

Silicone resin agglomerates may be present in the coating after curing. These silicone resin agglomerates may surround the fluoropolymer particles. A slight gradient may be observed in the coating after curing, in which the silicone resin binder may be present in a slightly higher concentration proximal to the substrate and in a slightly lower concentration distal to the substrate, proximal to the surface. Additionally, based on the SEM image shown in FIG. 9, the silicone oil is expected to be found in proximity to the silicone resin, which in turn surrounds the fluoropolymer particles. Due to the low silicone oil loading in the formulations of the present disclosure, it is not possible to distinguish the two silicone-containing materials (i.e., silicone oil and silicone resin). However, there is a high silicone detection from the energy dispersive spectroscopy (EDS, elemental analysis) probe in the proximity of the area surrounding the fluoropolymer particles. For this reason, it is expected that the two silicone-containing materials would be located in that area following the curing process.

On the coating surface, the fluoropolymer may be distributed homogenously throughout the surface. FIGS. 9 and 10 show a SEM images (15 kV) of a silicone oil/fluoropolymer/silicone resin coating surface of the present disclosure after curing, as described in Example 1. The silicone resin and the silicone oil are incorporating the fluoropolymer thus avoiding fluoropolymer blooming. The fluoropolymer appears homogeneously distributed throughout the coating.

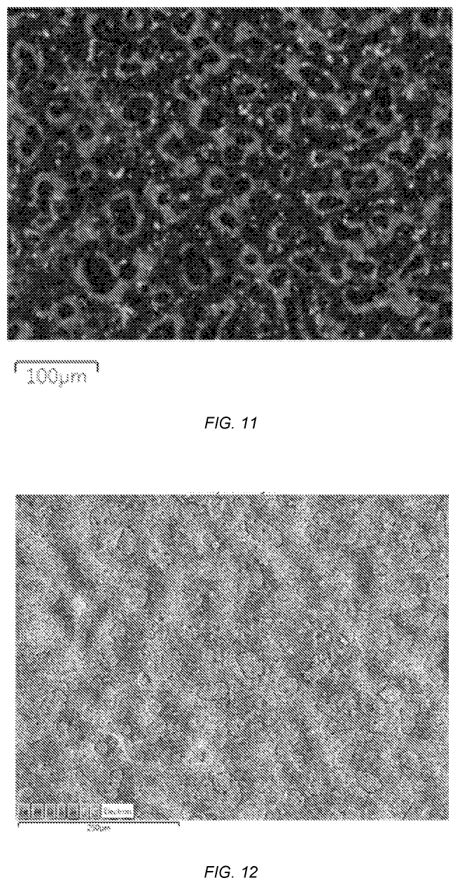

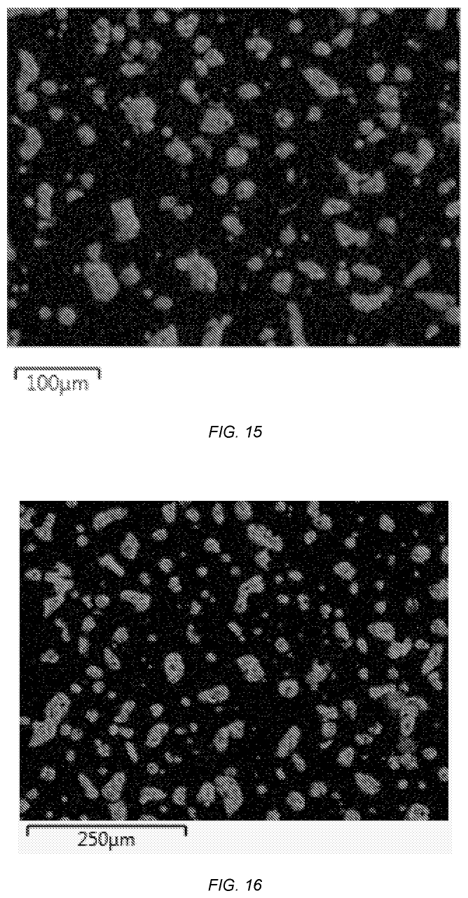

FIG. 15 shows an EDX image (F Kα_{1,2}) of the coating of FIG. 9, showing the fluorine atoms (grey). FIG. 11 shows an EDX image (Si Kα₁) of the coating of FIG. 9, showing the silicone atoms (grey).

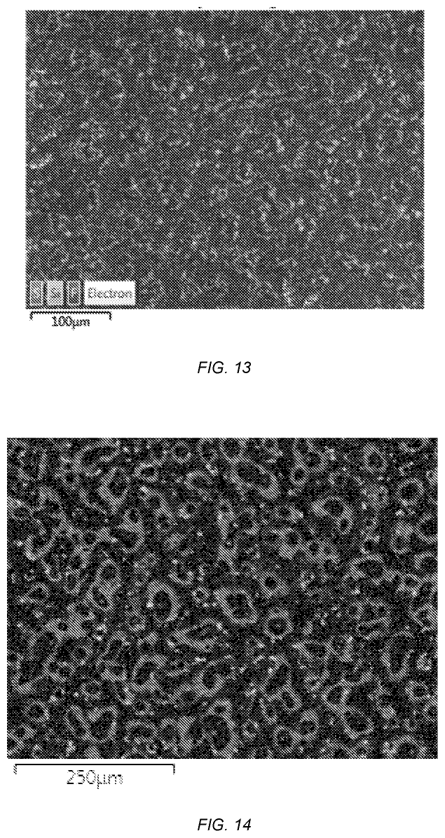

FIGS. 12 and 13 show a EDS layered images showing the Fe, Si, S, Al, F, O and C atom distribution of a silicone oil/fluoropolymer/silicone resin coating surface of the present disclosure after curing. The silicone resin surrounds the fluoropolymer (PTFE micropowder) droplets on the coating surface, creating a stable structure. FIG. 16 shows an EDX image (F Kα_{1,2}) of the coating of FIG. 12, showing the fluorine atoms (grey). FIG. 14 shows an EDX image (Si Kα₁) of the coating of FIG. 12, showing the silicone atoms (grey).

Accordingly, it is believed that being surrounded by the silicone resin, the fluoropolymer is protected from the detrimental effect of the silicone oil. Consequently, the blooming effect is prevented, and the fluoropolymer and silicone oil are kept in place at the uppermost layer of the coating where they can exhibit their release properties.

The introduction of the silicone resin in the formulation to achieve the fluoropolymer optimal incorporation in the coating film is a benefit of the formulation of the present disclosure. The inclusion of the silicone resin brings about the fluoropolymer incorporation, thus avoiding the blooming effect.

It was surprisingly found that the combination of fluoropolymer, silicone oil and silicone resin in the formulation results in a coating with exceptionally high release properties and improved durability while avoiding any blooming of the fluoropolymer.

### EXAMPLES

Examples of granular PTFE micropowders include Ultraflon™ MP-8T, Ultraflon™ MP-10, Ultraflon™ MP-25, Ultraflon™ MP-55 obtained from Laurel Products, LLC; Zonyl® MP1200, MP1300, and MP1400 resins, available from, DuPont (Zonyl® is a registered trademark of E.I. du Pont de Nemours & Co.). Aluminium flake pigment paste in the form of solvent wetted aluminium paste is available from e.g. Silberline Manufacturing Co., Inc. Solvents gamma butyrolactone and Solvesso™ 100 (aromatic fluid) are available from e.g. Sigma Aldrich, Inc., or Nexeo Solutions, Inc. The flow agent, the silicon carbide, the polytetrafluoroethylene micropowder, and the silicone oil are available from The Dow Chemical Company, among others.

### Comparative Example A: Coatings Resulting in Fluoropolymer Blooming

A coating was prepared according to Table 7, below.

TABLE 7

| | Amount (wt. %) | Amount (wt. %) |
|---|---|---|
| | in liquid | in dry |
| Component | composition | coating |
| Polytetrafluoroethylene | 1.615 | 7.52 |
| (incorporated in the | | |
| polyethersulfone resin) | | |
| Polytetrafluoroethylene | 0.543 | 2.53 |
| (introduced in | | |
| micropowder form) | | |
| Flow additive | 0.592 | 2.27 |
| Carbon Black pigment | 0.181 | 2.92 |
| Solvent blend | 78.86 | 0.000 |
| Polyethersulfone resin | 17.83 | 82.99 |
| Silicone oil | 0.380 | 1.77 |
| Total | 100.000 | 100.000 |

FIGS. 2 and 3 show the aggregation of spherical particles on the surface of the coating. As shown in FIG. 8, blooming was noted on the coated surface following the application of slight friction.

### Example 1: Coating Composition using PTFE Micropowder

A coating composition was formulated in accordance with Table 8, below.

TABLE 8

| | Amount (wt. %) | Amount (wt. %) |
|---|---|---|
| | in liquid | in final |
| Component | composition | coating |
| Polytetrafluoroethylene | 5.096 | 16.41 |
| (PTFE)incorporated in | | |
| the polyethersulfone resin | | |
| Polytetrafluoroethylene | 0.908 | 2.92 |
| introduced in | | |
| micropowder form | | |
| Flow additive | 0.631 | 1.68 |
| Carbon Black pigment | 0.181 | 0.59 |
| Aluminium pigment | 4.293 | 10.37 |
| Solvent Blend 1 | 67.76 | 0.000 |
| Polyethersulfone resin | 16.760 | 53.99 |
| Silicone oil | 0.642 | 2.07 |
| Hydroxy functional silicone resin | 3.280 | 10.51 |
| Silicon carbide | 0.454 | 1.46 |
| Total | 100.000 | 100.000 |

FIG. 10 is an SEM image of the coating following curing. FIG. 13 is an EDS qualitative analysis showing the distribution of the elements sulfur, silicon (surrounding the fluoropolymer agglomerates) and fluorine across the coated surface.

### Example 2: Coating Composition Using FEP Micropowder

A coating composition was formulated in accordance with Table 9, below.

TABLE 9

| | Amount (wt. %) | Amount (wt. %) |
|---|---|---|
| | in liquid | in dry |
| Component | composition | coating |
| Fluorinated ethylene propylene | 1.990 | 8.140 |
| (FEP) micropowder incorporated | | |
| in the polyethersulfone resin | | |
| Flow additive | 0.520 | 1.770 |
| Matting agent | 1.870 | 6.710 |
| Carbon Black pigment | 0.556 | 2.280 |
| Aluminium pigment | 0.464 | 1.420 |
| Solvent blend 3 | 75.111 | 0.000 |
| Polyethersulphone resin | 16.070 | 65.750 |
| Silicone oil | 0.189 | 0.780 |
| Hydroxy functional silicone resin | 3.230 | 13.150 |
| Total | 100.000 | 100.000 |

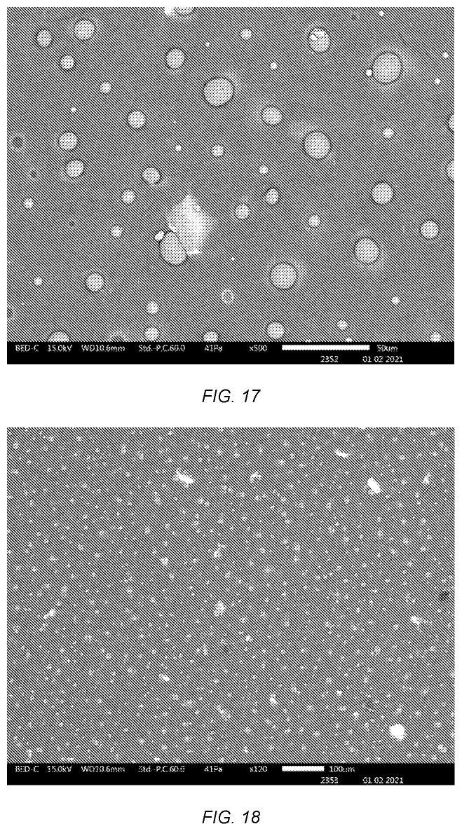

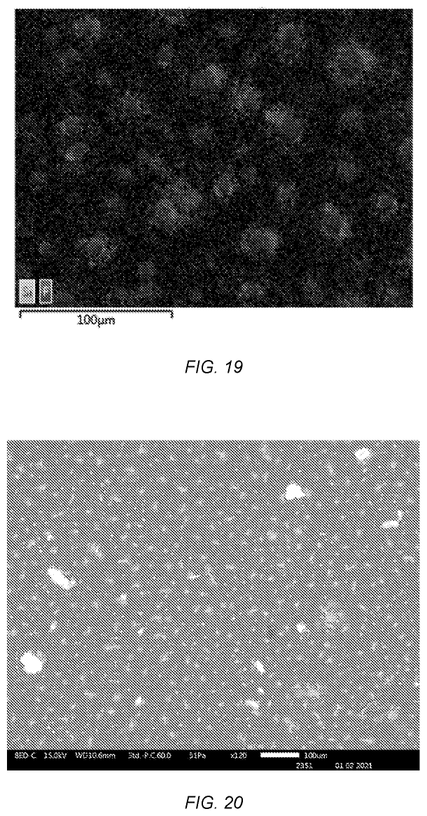

FIGS. 17 and 18 show SEM images of the coating surface following curing at 500× and 120× magnification, respectively. FIG. 19 is an EDX image showing the distribution of silicon and fluorine on the surface of the coating. As can be seen in these images, fluoropolymer blooming is not present in this coating composition.

### Example 3: Coating Composition with PFA Micropowder

A coating composition was formulated in accordance with Table 10, below.

| | Amount (wt. %) | Amount (wt. %) |
|---|---|---|
| | in liquid | in dry |
| Component | composition | coating |
| Tetrafluoroethylene copolymer | 2.048 | 8.430 |
| and perfluorinated comonomers | | |
| (PFA) incorporated in the | | |
| polyethersulfone resin | | |
| Flow additive | 0.552 | 1.870 |
| Matting agent | 1.765 | 6.900 |
| Carbon Black pigment | 0.587 | 2.420 |
| Aluminium pigment | 0.489 | 1.510 |
| Solvent blend 3 | 75.373 | 0.000 |
| Polyethersulphone resin | 15.577 | 64.100 |
| Silicone oil | 0.200 | 0.820 |
| Hydroxy functional silicone resin | 3.408 | 13.950 |
| Total | 100.000 | 100.000 |

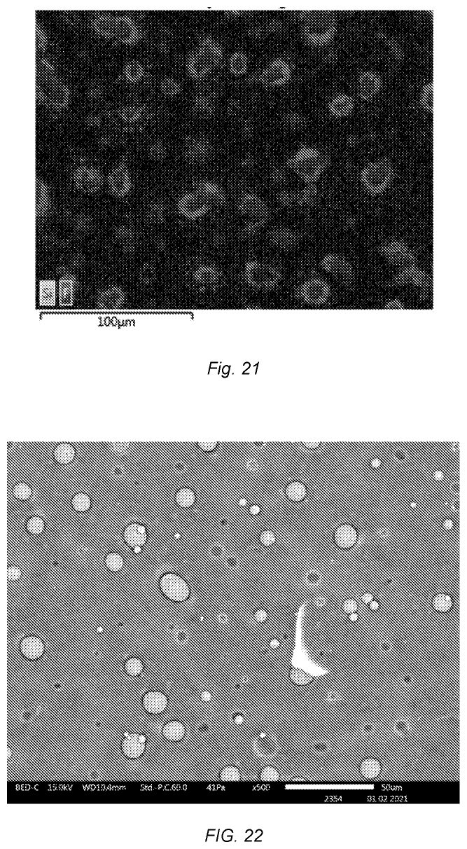

FIG. 20 is an SEM image of the coating after curing at 120Δ magnification, and FIG. 21 is an EDX image of the coating, showing the distribution of silicon and fluorine across the coating surface.

### Example 4: Coating Composition using PAI Resin

A coating composition was formulated according to Table 11, below.

TABLE 11

| | Amount (wt. %) | Amount (wt. %) |
|---|---|---|
| | in liquid | in dry |
| Component | composition | coating |
| Polyamide-imide resin | 9.090 | 11.890 |
| (PAI) resin dispersion | | |
| F8luorinated ethylene | 1.832 | 7.350 |
| propylene (FEP) micropowder | | |
| (incorporated in the | | |
| polyethersulfone resin) | | |
| Flow additive | 0.540 | 1.560 |
| Matting agent | 1.521 | 5.730 |
| Carbon Black pigment | 0.506 | 2.010 |
| Aluminium pigment | 0.421 | 1.250 |
| Solvent blend 1 | 68.370 | 0.000 |
| Polyethersulphone resin | 14.610 | 57.940 |
| Silicone oil | 0.172 | 0.680 |
| Hydroxy functional silicone resin | 2.938 | 11.590 |
| Total | 100.000 | 100.000 |

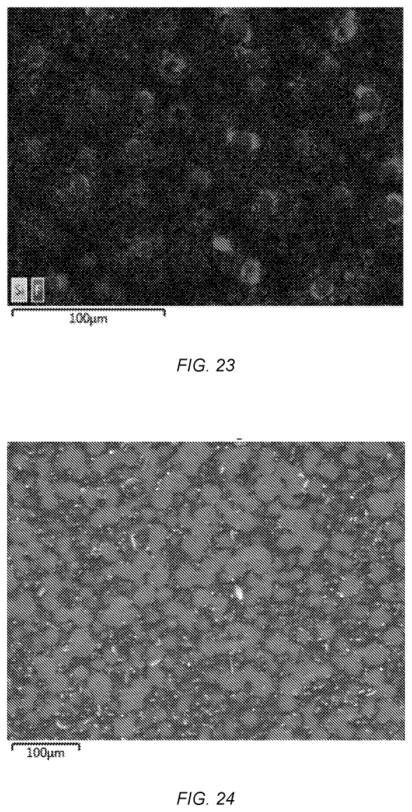

FIG. 22 shows an SEM image of the coating after curing at 500× magnification, while FIG. 23 in an EDX image showing the distribution of silicon and fluorine in the coating.

### Example 5: Coated Article

A coating formulation was made in accordance with Table 12, below, which includes the amounts of the components in both the liquid or “wet” coating composition and the final, applied and cured, or “dry” coating.

TABLE 12

| | Amount (wt. %) | Amount (wt. %) |
|---|---|---|
| | in liquid | in final |
| Component | composition | coating |
| Polytetrafluoroethylene | 1.486 | 5.939 |
| (incorporated in the | | |
| polyethersulfone resin) | | |
| Polytetrafluoroethylene | 0.500 | 1.998 |
| (introduced in | | |
| micropowder form) | | |
| Flow additive | 0.550 | 1.814 |
| Matting agent | 1.739 | 6.603 |
| Carbon Black pigment | 0.570 | 2.278 |
| Aluminum pigment | 0.482 | 1.445 |
| Solvent Blend 3 | 74.660 | 0.000 |
| Polyethersulfone resin | 16.459 | 65.785 |
| Silicone oil | 0.197 | 0.787 |
| Hydroxy functional silicone resin | 3.357 | 13.350 |
| Total | 100.0 | 100.0 |

In this Example, the coil coating process was replicated using bar coating, the analogous method for lab development. An excess of the liquid or “wet” coating composition is placed on a piece of metal substrate, and it is spread across the substrate by a bar. This bar is a spiral film applicator; a long cylindrical bar with wire spiraling around it. The gaps made between the wire and the substrate determine how much of the liquid composition passes through, thereby determining the film thickness. The coated metal substrate is the cured in the lab static oven and quenched under running tap water. This process, described in ASTM D4147, best replicates the actual industrial coil coating process.

### Example 6: Cake Release Test

The baking dish coated in accordance with Example 5 was used in a cake release test to evaluate coating performance. A cake mix comprising of a set amount of flour, butter, sugar and eggs is used to carry out 5 release tests in the pressed cake tin. Each baking cycle is carried out at 180° C. for 30 minutes. The cake tin is greased prior to the first cycle only and subsequent cycles are carried out without greasing. The aim of the test is to have no residue or crumbs in the cake tin after releasing the cake. A score is awarded after each cycle based on visual assessment in accordance with the EN 13834 Annex C. In order to stress the release performance, the coated substrate was greased prior pouring the cake mix on the coated substrate for the first cycle only. Table 13 below illustrates the scoring method.

TABLE 13

| | | Residues remaining |
|---|---|---|
| Score | Release | prior to cleaning |
| 100% | Cake falls from item | <20% |
| 75% | Cake falls from item | 20-40% |
| 50% | Force required to remove cake from item | 40-60% |
| 25% | Force required to remove cake from item | 60-100% |
| 0% | Cake stuck to item | Cake remaining |

Coating A is a standard fluoropolymer containing coating. FIG. 24 shows an SEM image showing the surface of this standard fluoropolymer containing coating product, and FIG. 25 shows an EDS compositional analysis of this standard fluoropolymer containing product, in which the distribution of sulfur, carbon and fluorine can be appreciated across the coated surface. Coating B is a coating of the present disclosure comprising a fluoropolymer component, a silicone oil and a hydroxy-functional silicone resin. The results of the cake release tests are shown below in Table 14.

TABLE 14

| Coating | Cycle 1 | Cycle 2 | Cycle 3 | Cycle 4 | Cycle 5 |
|---|---|---|---|---|---|
| A | 75 | 25 | 25 | 25 | 25 |
| B | 100 | 100 | 100 | 100 | 100 |

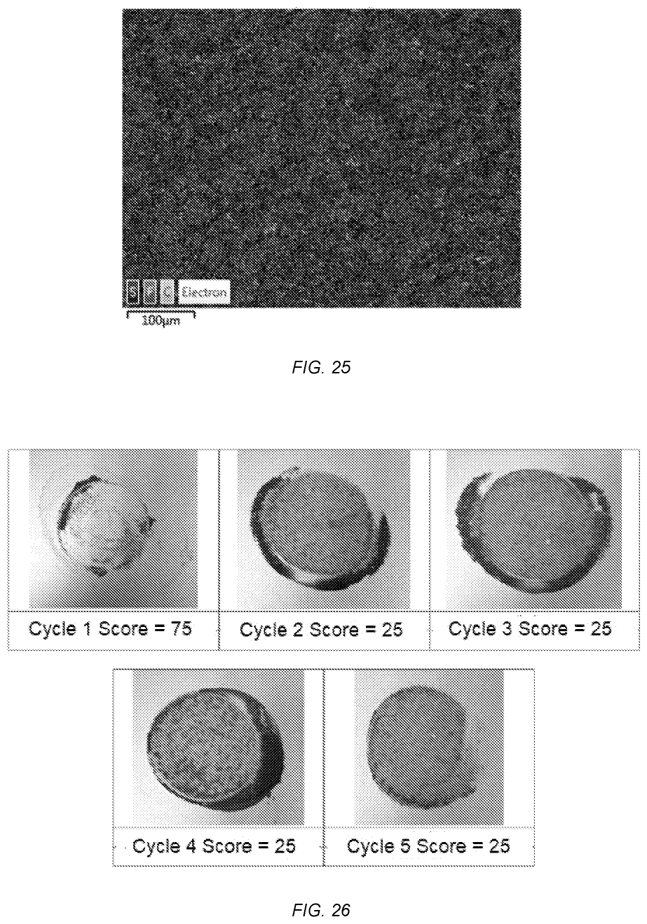

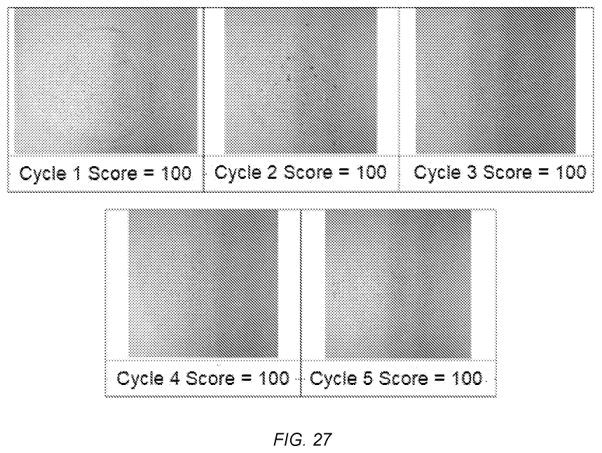

The test results for coating A and B are depicted in FIGS. 19 and 20, respectively. As shown in FIG. 26, the standard fluoropolymer coating product earned a score of 75 after the first cycle (upper left photo, showing little remaining residue); however, each successive test resulted in poor performance (a score of 25, remaining photos showing considerable residue remaining). In contrast, the coatings of the present disclosure performed well in each cycle, as shown in FIG. 27. The tests in each of the five cycles resulted in less than 20% residue remaining, with no detectable decrease in performance over successive tests.

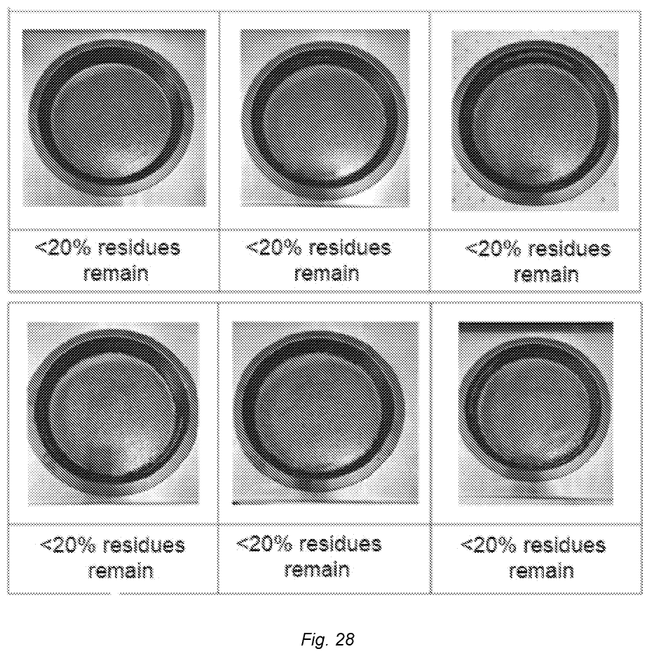

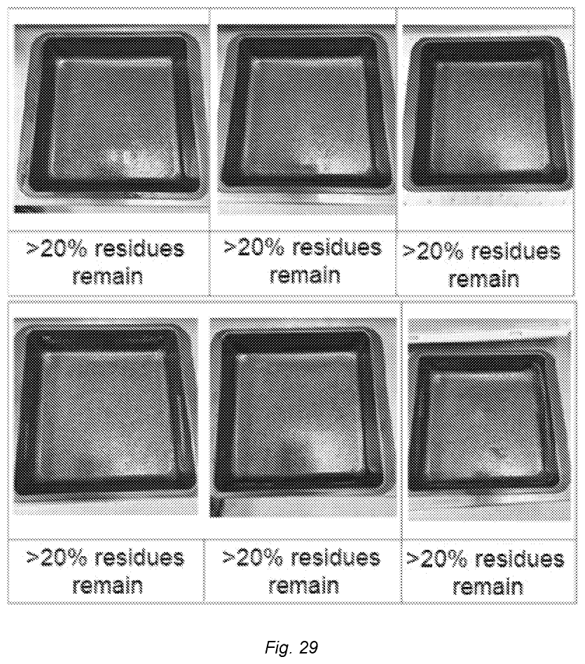

The coating described in Table 12 was applied via coil coating during a line trial. The coated sheets were then pressed into two shapes, a round pie tin and a baking tray. These articles were then subjected to the cake release test described above, undergoing six cycles. FIG. 28 shows the results of the cake release test for the round pie tin, with the results of cycles 1-3 shown from left to right across the top of the figure and cycles 4-6 shown from left to right across the bottom. After each cycle, less than 20% residue remained. FIG. 29 shows the results of the cake release test for the baking tray, again with the first three cycles shown from left to right across the top of the figure and the final three cycles shown from left to right across the bottom. As in the test with the round pie tin, less than 20% residue remained after each cycle.

Wherein particular examples of this invention have been described above for purposes of illustration, it will be evident to those skilled in the art that numerous variations of the details of the present invention may be made without departing from the invention as defined in the appended claims.

### Aspects

Aspect 1 is a coating composition, comprising: a fluoropolymer component in the form of a fluoropolymer micropowder having weight average molecular weight of from 300,000 g/mol to 400,000 g/mol, as determined by melt flow index analysis; a binder resin; a hydroxy-functional silicone resin; a silicone oil; and at least one solvent.

Aspect 2 is the coating composition of Aspect 1, wherein the fluoropolymer micropowder component is selected from the group comprising polytetrafluoroethylene (PTFE) micropowder, perfluoroalkoxy polymer (PFA) micropowder, and fluorinated ethylene propylene (FEP) micropowder.

Aspect 3 is the coating composition of either Aspect 1 or Aspect 2, wherein the fluoropolymer micropowder component comprises polytetrafluoroethylene (PTFE) micropowder.

Aspect 4 is the coating composition of any of Aspects 1-3, wherein the binder resin is selected from polyamide-imide (PAI), polyethersulfone (PES), polyphenylsulfone (PPSU), and polysulfone (PSU) and combinations of the foregoing.

Aspect 5 is the coating composition of any of Aspects 1-4, wherein the binder resin comprises polyethersulfone (PES).

Aspect 6 is the coating composition of any of Aspects 1-5, wherein the weight average molecular weight of the binder resin is at least 10,000 g/mol, as determined by ASTM D5296.

Aspect 7 is the coating composition of any of Aspects 1-6, wherein the hydroxy-functional silicone resin is selected from phenyl silicone, methyl silicone, methyl phenyl silicone and combinations of the foregoing.

Aspect 8 is the coating composition of any of Aspects 1-7, wherein the hydroxy content of the hydroxy-functional silicone resin is 4 wt. % to 8 wt. %, based on the weight of the hydroxy-functional silicone resin.

Aspect 9 is the coating composition of any of Aspects 1-8, wherein the hydroxy-functional silicone resin has a weight average molecular weight from 1500 g/mol to 4500 g/mol, as determined by DIN Standard 55672.

Aspect 10 is the coating composition of any of Aspects 1-9, comprising from 0.1 wt. % to 10 wt. % of the fluoropolymer component having a weight average molecular weight of from 300,000 g/mol to 400,000 g/mol as determined by melt flow index analysis, based on a total weight of the coating composition.

Aspect 11 is the coating composition of any of Aspects 1-10, comprising from 10 wt. % to 20 wt. % of the binder resin, based on a total weight of the coating composition.

Aspect 12 is the coating composition of any of Aspects 1-11, comprising from 0.1 wt. % to 1.0 wt. % of the silicone oil, based on a total weight of the coating composition.

Aspect 13 is the coating composition of any of Aspects 1-12, comprising from 2.0 wt. % to 7.0 wt. % of the hydroxy-functional silicone resin, based on a total weight of the coating composition.

Aspect 14 is the coating composition of any of Aspects 1-13, further comprising at least one solvent.

Aspect 15 is a coated article comprising a rigid substrate and a coating on said rigid substrate, wherein the coating comprises: a fluoropolymer micropowder component having a weight average molecular weight of from 300,000 g/mol to 400,000 g/mol, as determined by melt flow index analysis; a resin binder; a hydroxy-functional silicone resin; and silicone oil.

Aspect 16 is the coating composition of Aspect 15, wherein the coating comprises from 0.5 wt. % to 7 wt. % of the fluoropolymer component having a molecular weight of from 300,000 g/mol to 400,000 g/mol as determined by melt flow index analysis, based on a total weight of the coating.

Aspect 17 is the coating composition of either Aspect 15 or Aspect 16, wherein the coating comprises 50 wt. % to 70 wt. % of the resin binder, based on a total weight of the coating.

Aspect 18 is the coating composition of any of Aspects 15-17, wherein the coating of the composition comprises 9 wt. % to 14 wt. % of the hydroxy-functional silicone resin, based on a total weight of the coating.

Aspect 19 is the coating composition of any of Aspects 15-18, wherein the coating of the composition comprises 0.5 wt. % to 2.5 wt. % of the silicone oil, based on a total weight of the coating.

Aspect 20 is a coated article according to any of Aspects 15-19, wherein the article comprises an article of bakeware and/or cookware.

1. A coating composition, comprising:
a fluoropolymer component in the form of a fluoropolymer micropowder having a weight average molecular weight of from 300,000 g/mol to 400,000 g/mol, as determined by melt flow index analysis;
a binder resin;
a hydroxy-functional silicone resin;
a silicone oil; and
at least one solvent.

2. The coating composition of claim 1, wherein the fluoropolymer micropowder component is selected from the group comprising polytetrafluoroethylene (PTFE) micropowder, perfluoroalkoxy polymer (PFA) micropowder, and fluorinated ethylene propylene (FEP) micropowder.

3. The coating composition of claim 2, wherein the fluoropolymer micropowder component comprises polytetrafluoroethylene (PTFE) micropowder.

4. The coating composition of claim 1, wherein the binder resin is selected from polyamide-imide (PAI), polyethersulfone (PES), polyphenylsulfone (PPSU), and polysulfone (PSU) and combinations of the foregoing.

5. The coating composition of claim 4, wherein the binder resin comprises polyethersulfone (PES).

6. The coating composition of claim 1, wherein the weight average molecular weight of the binder resin is at least 10,000 g/mol, as determined by ASTM D5296.

7. The coating composition of claim 1, wherein the hydroxy-functional silicone resin is selected from phenyl silicone, methyl silicone, methyl phenyl silicone and combinations of the foregoing.

8. The coating composition of claim 1, wherein the hydroxy content of the hydroxy-functional silicone resin is 4 wt. % to 8 wt. %, based on the weight of the hydroxy-functional silicone resin.

9. The coating composition of claim 1, wherein the hydroxy-functional silicone resin has a weight average molecular weight from 1500 g/mol to 4500 g/mol, as determined by DIN Standard 55672.

10. The coating composition of claim 1, comprising from 0.1 wt. % to 10 wt. % of the fluoropolymer component having a weight average molecular weight of from 300,000 g/mol to 400,000 g/mol as determined by melt flow index analysis, based on a total weight of the coating composition.

11. The coating composition of claim 1, comprising from 10 wt. % to 20 wt. % of the binder resin, based on a total weight of the coating composition.

12. The coating composition of claim 1, comprising from 0.1 wt. % to 1.0 wt. % of the silicone oil, based on a total weight of the coating composition.

13. The coating composition of claim 1, comprising from 2.0 wt. % to 7.0 wt. % of the hydroxy-functional silicone resin, based on a total weight of the coating composition.

14. The coating composition of claim 1, further comprising at least one solvent.

15. A coated article comprising a rigid substrate and a coating on said rigid substrate, wherein the coating comprises:
a fluoropolymer micropowder component having a weight average molecular weight of from 300,000 g/mol to 400,000 g/mol, as determined by melt flow index analysis;
a resin binder;
a hydroxy-functional silicone resin; and
silicone oil.

16. The coating composition of claim 15, wherein the coating comprises from 0.5 wt. % to 7 wt. % of the fluoropolymer component having a weight average molecular weight of from 300,000 g/mol to 400,000 g/mol as determined by melt flow index analysis, based on a total weight of the coating.

17. The coating composition of claim 15, wherein the coating comprises 50 wt. % to 70 wt. % of the resin binder, based on a total weight of the coating.

18. The coating composition of claim 15, wherein the coating comprises 9 wt. % to 14 wt. % of the hydroxy-functional silicone resin, based on a total weight of the coating.

19. The coating composition of claim 15, wherein the coating of the composition comprises 0.5 wt. % to 2.5 wt. % of the silicone oil, based on a total weight of the coating.

20. A coated article according to claim 15, wherein the article comprises an article of bakeware and/or cookware.
